(19) United States
(12) Patent Application Publication
(10) Pub. No.: US 2026/0003551 A1
(43) Pub. Date: Jan. 1, 2026

(54) NON-TRANSITORY COMPUTER-READABLE STORAGE MEDIUM STORING INSTRUCTIONS REALIZING SUPPORTING PROGRAM

(71) Applicant: BROTHER KOGYO KABUSHIKI KAISHA, Nagoya (JP)

(72) Inventors: Yushi ICHIKAWA, Nagoya (JP); Kenju NARITA, Nagoya (JP); Yoshito HOSOMIZO, Konan (JP); Airi EGUCHI, Ichinomiya (JP)

(21) Appl. No.: 19/318,053

(22) Filed: Sep. 3, 2025

Related U.S. Application Data
(63) Continuation of application No. PCT/JP2024/007008, filed on Feb. 27, 2024.

(30) Foreign Application Priority Data
Mar. 3, 2023 (JP) 2023-032468

(51) Int. Cl. G06F 3/12

(52) U.S. Cl. CPC G06F 3/125; G06F 3/1205; G06F 3/1207; G06F 3/1253

(57) ABSTRACT

A supporting program for a printer supports multiple sheet sizes. The supporting program, when executed by a controller of an information processing device, causes the information processing device to, in response to receiving a request from a universal printing program, obtain sheet size data representing a sheet size list including a first-type sheet size, and generate document size data including available document sizes including the first-type sheet size and a second-type sheet size. When the universal printing program receives a print instruction from an application program, the supporting program causes the information processing device to determine whether a document size of an image to be printed is included in the first-type sheet size; when the document size is not included in the first-type sheet size, scale the image to fit the first-type sheet size; and cause the printer to print the image to be printed or a scaled image.

### REFERENCE TO RELATED APPLICATIONS

This is a continuation application of International Application No. PCT/JP2024/007008 filed on Feb. 27, 2024, which claims priority from Japanese Patent Application No. 2023-032468 filed on Mar. 3, 2023. The entire contents of the aforementioned applications are incorporated herein by reference.

### BACKGROUND ART

Some known techniques have been developed in which a printer driver scales (i.e., enlarges or reduces) an image to be printed to a specific size. For example, one technique involves a printer driver that is capable of handling both XML files and EMF files, and that has a scaling function for adjusting a print area.

### SUMMARY

Another technique may involve controlling a printer using an OS-standard universal printing program that is part of an operating system (OS), without requiring a printer driver provided by a printer vendor. More specifically, for example, in response to detecting a printer, the OS may establish association between the printer and the OS-standard universal printing program. Thereafter, in response to the OS receiving a print instruction for the printer, the OS-standard universal printing program may generate print data without a printer driver provided by a printer vendor, thereby enabling printing through the OS-standard universal printing program.

However, there is no disclosure of a technique for scaling and printing an image received from an application program when an information processing device causes a printer to perform printing via the above-described OS-standard universal printing program. Therefore, if the application program that passes an image to be printed to the universal printing program does not have a scaling function, the image to be printed might not be printed after scaling.

According to an aspect of the disclosure, a non-transitory computer-readable storage medium for an information processing device is provided, which includes a controller and stores computer-executable instructions that are executable by the controller. The computer-executable instructions implement a supporting program for a printer connectable to the information processing device. The information processing device has an operating system including a universal printing program. The information processing device is incorporated with an application program. The supporting program supports a plurality of particular sheet sizes. In response to the supporting program receiving a particular request from the universal printing program, the supporting program, that when executed by the controller, causes the information processing device to perform: obtaining sheet size data representing a sheet size list including at least one first-type sheet size that is supported by the printer; and generating document size data including document sizes to enable selection of one of the document sizes, the document sizes including the at least one first-type sheet size and at least one second-type sheet size, the at least one second-type sheet size being included in the plurality of particular sheet sizes supported by the supporting program and not included in the sheet size data. In response to the universal printing program receiving, from the application program, a print instruction that causes the printer to perform printing, the supporting program, that when executed by the controller, causes the information processing device to perform: determining whether a document size of an image to be printed based on the print instruction is included in the at least one first-type sheet size; based on the determination that the document size of the image to be printed is not included in the at least one first-type sheet size, scaling the image to be printed to fit one of the at least one first-type sheet size to generate a scaled image of the image to be printed; and causing the printer to print the image to be printed, wherein in a case where the scaled image is generated, the scaled image is printed.

According to the aspect of the disclosure, in response to a request from the universal printing program, the supporting program generates a list of document sizes including at least one sheet size that is not supported by the printer, and allows a user to select one of the at least one document size from the list. This may thus enable printing of an image in a document size not supported by the printer. When an image in a document size not supported by the printer 2 is to be printed, the supporting program 42 may perform scaling on an image to be printed to fit one of the sheet sizes supported by the printer. Such a configuration may thus enable the printer to print an image passed from the editing application on a sheet of a size supported by the printer.

Information processing devices having the supporting program is installed, non-transitory computer-readable storage media storing the supporting program, control methods for implementing the functions of the supporting program, and printing systems including the supporting program and a printer may also have novelty and utility.

According to aspects of the disclosure, a technique of printing an image to be printed after scaling may be implemented in an information processing device in which an OS-standard universal printing program is installed.

### BRIEF DESCRIPTION OF THE DRAWINGS

FIG. 1 is a block diagram schematically illustrating an electrical configuration of a personal computer.

FIG. 2A is a sequence diagram illustrating an example of a print settings specifying procedure. FIG. 2B is a continuation of FIG. 2A.

FIG. 3 illustrates an example of a print settings screen.

FIG. 4 illustrates an example of an advanced settings screen.

FIG. 5 illustrates an example of a size list screen.

FIG. 6 illustrates an example of a sheet selection dialog.

FIG. 7 is a sequence diagram illustrating an example of an image generation procedure.

FIG. 8 is a sequence diagram illustrating an example of a print execution procedure.

### DESCRIPTION

Hereinafter, a personal computer (“PC”) using a supporting program of an illustrative embodiment will be described in detail with reference to the accompanying drawings. The disclosure discloses the supporting program executed by the PC.

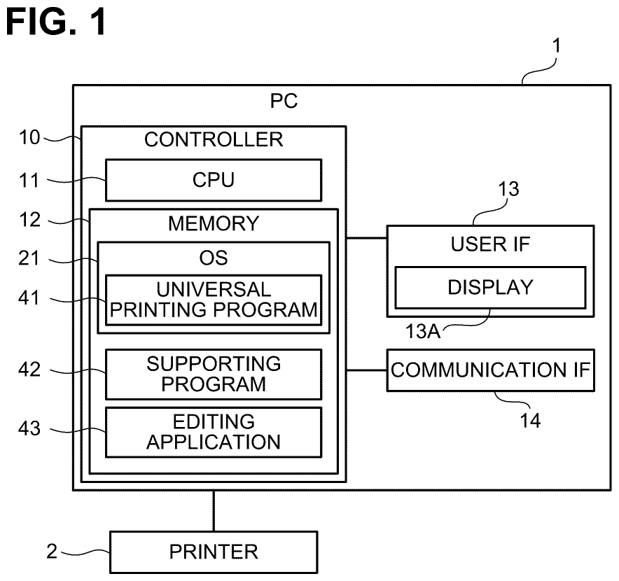

As illustrated in FIG. 1, a PC 1 of the illustrative embodiment includes a controller 10 including a CPU 11 and a memory 12. The PC 1 is an example of an information processing device. The CPU 11 is an example of a computer. The PC 1 includes a user interface (“user IF”) 13 and a communication interface (“communication IF”) 14, which are electrically connected to the controller 10. The term “controller 10” used in FIG. 1 may be a collective term for hardware and software used to control the PC 1, and might not necessarily represent a single piece of hardware actually existing in the PC 1.

The CPU 11 of the PC 1 executes various types of processing in accordance with a program read from the memory 12 or based on user input. The memory 12 stores various programs and data. The memory 12 also serves as a workspace for processing. A buffer of the CPU 11 is an example of the memory 12. Examples of the memory 12 further include storage media readable and writable by the CPU 11, for example, recording media such as CD-ROMs and DVD-ROMs, as well as a ROM, a RAM, a hard disk drive built in the PC 1.

The user IF 13 includes a display 13a, which is hardware for displaying information to a user. Further, the user IF 13 includes hardware for user input. In one example, the user IF 13 may be a combination of the display 13a and an input device, such as a mouse and/or a keyboard. In another example, the user IF 13 may be a touch screen having both display and input functions.

The communication IF 14 includes hardware that enables the PC 1 to communicate with an external device such as the printer 2. Examples of a communication standard for the communication IF 14 include Ethernet, Wi-Fi, and USB. Ethernet is a registered trademark of Fuji Xerox Co., Ltd. Wi-Fi is a registered trademark of Wi-Fi Alliance. The PC 1 may be connectable to the Internet via the communication IF 14. The PC 1 may include multiple communication IFs 14 for supporting multiple communication standards.

As illustrated in FIG. 1, the memory 12 of the PC 1 stores various data and programs, including an operating system (“OS”) 21, a supporting program 42, and an editing application 43. The OS 21 includes a universal printing program 41. The supporting program 42 is an example of a supporting program. The editing application 43 is an example of an application program.

The OS 21 may be a multitasking OS that manages multiple tasks and switches between the multiple tasks, thereby handling several tasks simultaneously. The OS 21 may be, for example, Windows, macOS, Linux, iOS, or Android. Windows is a trademark of the Microsoft group of companies. macOS is a registered trademark of Apple Inc. Linux is a registered trademark of Linus Torvalds. iOS is a registered trademark of Cisco Systems, Inc. Android is a registered trademark of Google LLC.

The OS 21 includes the universal printing program 41. The universal printing program 41 is an OS-standard program that is developed by a vendor of the OS 21 and provided as part of the OS 21. That is, the PC 1 is equipped with the OS 21 having the universal printing program 41. The universal printing program 41 is designed to allow for the absence of printer-specific drivers.

The universal printing program 41 enables various types and models of printers provided by different vendors to perform printing based on user instructions. The universal printing program 41 supports general functions that enable various printers to perform printing. Unlike printer-specific drivers, the universal printing program 41 does not support a specific function that a printer or printer driver has, in particular, a function requiring complicated processing.

The universal printing program 41 includes a function of generating intermediate image data based on image data received as data to be printed that has been specified in a print instruction received from an application, based on a user instruction. The intermediate image data may be, for example, data in XPS format. “XPS” is an abbreviation for XML Paper Specification. The universal printing program 41 further has a function of generating print data in a format available for printing by various types of printers based on the intermediate image data. The print data may be, for example, PWG Raster data or PDF data. The universal printing program 41 further has a function of transmitting the generated print data to a printer designated as a device for printing, using a communication function of the OS 21.

The supporting program 42 consists of a single program or a group of programs that execute processing based on an instruction received from the OS 21 in association with the processing executed by the universal printing program 41, and that support control of target hardware. The supporting program 42 is provided for the model of the printer 2 connected to the PC 1, for example, by the vendor of the printer 2. The universal printing program 41 activates the supporting program 42 for the printer 2 based on a specific condition. The specific condition may be, for example, the designation of the printer 2 as a device for printing, the reception of an instruction to specify advanced print settings while the printer 2 is designated, or the reception of an instruction to cause the printer 2 to perform printing. The supporting program 42 may be, for example, a Print Support Application (“PSA”) or a Hardware Support Application (“HSA”).

In one example, the supporting program 42 may be a combination of a plurality of programs that receive execution commands, respectively. In another example, the supporting program 42 may be a single program configured to execute different types of processing based on received commands. Supporting programs may be prepared for different types of printers by a printer vendor. For example, one supporting program may be for inkjet printers and another supporting program may be for laser printers. Supporting programs may be prepared not only for types of printers but also for different models of printer or different series of printer models.

For example, when a particular printer is connected to the PC 1 for the first time, the OS 21 of the PC 1 may download a supporting program appropriate for the type or model of the printer from a server of the vendor of the printer, and install the supporting program on the PC 1. The OS 21 stores identification data of the installed supporting program into the memory 12 in association with printer data of the newly connected printer.

The editing application 43 may be, for example, a program for creating and editing image data and/or document data. The editing application 43 may be, for example, Microsoft Word or Microsoft PowerPoint developed by Microsoft or may be a program provided by the vendor of the printer 2. Microsoft, Microsoft PowerPoint, and Microsoft Word are trademarks of the Microsoft group of companies. The editing application 43 may receive, via the user IF 13, for example, a print execution instruction to cause the printer 2 to perform printing. The editing application 43 is not limited to programs for creating and editing data, and may also include programs that have a function of receiving instructions to display or print various types of information, such as map information or web pages, in response to a user's request.

As illustrated in FIG. 1, the PC 1 of the illustrative embodiment is connected to the printer 2 via the communication IF 14. The printer 2 has at least a printing function and a communication function. For example, in response to receiving print data from the PC 1, the printer 2 may perform printing based on the received print data. The printer 2 may be a color printer or a monochrome printer.

Hereinafter, a description will be provided on an operation of the PC 1 for causing printer 2 to perform printing. Processing executed in each step in the illustrative embodiment essentially indicates processing executed by the CPU 11 in accordance with instructions written in a specific program, such as the supporting program 42. Processing executed by the CPU 11 also includes control of hardware using APIs of the OS 21. In the disclosure, a description will be provided on operations of the programs. A detailed description of the OS 21 will be omitted. The terms referring to coming into possession are used as a concept that does not require necessarily a request to obtain that possession.

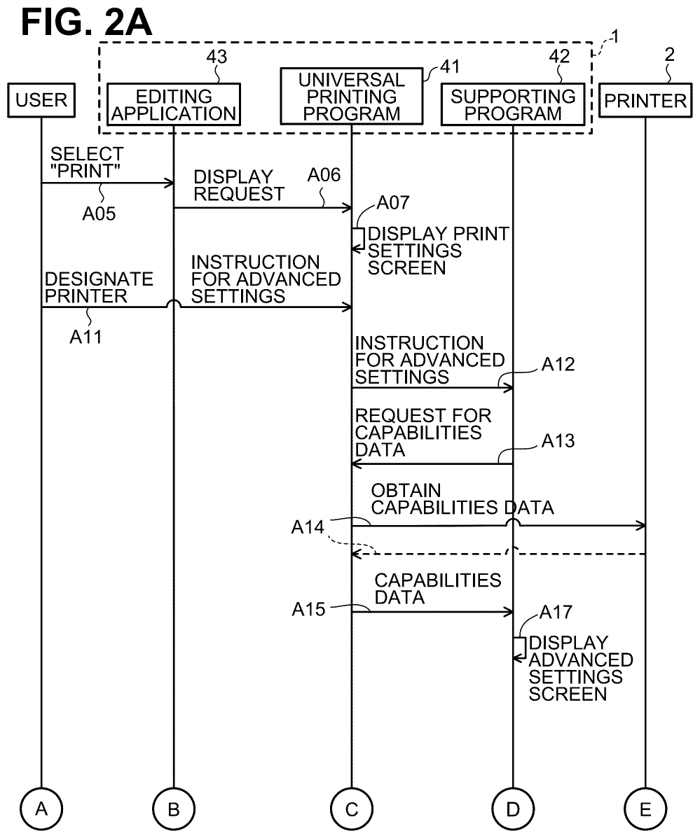

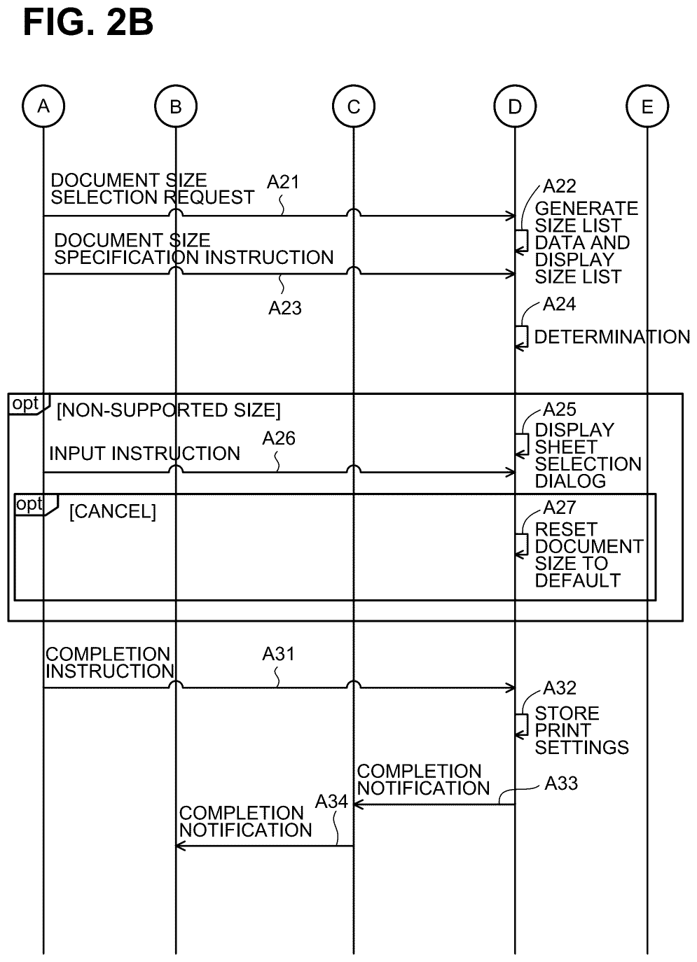

Referring to FIGS. 2A and 2B, a description will be provided on a print settings specifying procedure, which is performed in response to receiving a print setting instruction from a user. The print settings specifying procedure is performed to print a document or an image that has been created, for example, using the editing application 43. When printing an image based on data that has been edited using the editing application 43, the user selects “Print” on the editing application 43 (A05). For example, the user may select “Print” from a menu of operation items listed in the editing application 43.

In response to the user selecting “Print”, the editing application 43 requests the universal printing program 41 of the OS 21 to display a screen that allows the user to input an instruction relating to printing (A06). In response to the display request, the universal printing program 41 displays a print settings screen on the user IF 13 (A07). The print settings screen allows the user to specify print settings that are available to the universal printing program 41. In other embodiments, for example, displaying the print settings screen may be implemented by the editing application 43.

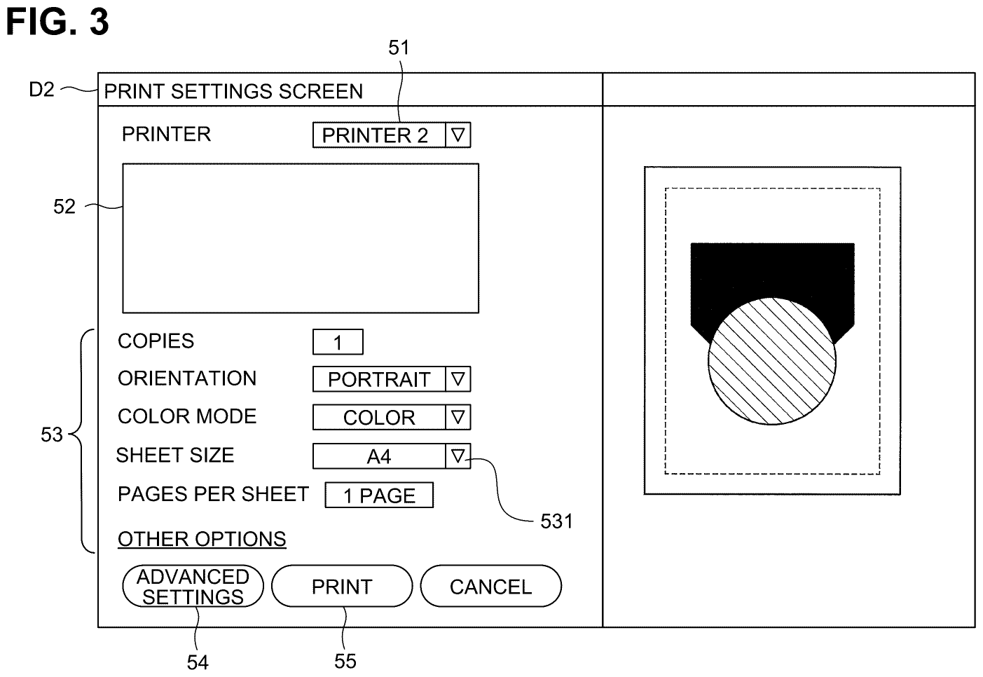

FIG. 3 illustrates an example of the print settings screen. An example print settings screen D2 includes a printer selection field 51, an information display field 52, basic print settings specification fields 53, an “advanced settings” button 54, and a “print” button 55. The printer selection field 51 allows the user to designate a device for printing. The information display field 52 displays information specified by the supporting program 42 for the device designated in the printer selection field 51. For example, in response to the designation of the printer 2 in the printer selection field 51 or in response to the reception of a print instruction through the “print” button 55 while the printer 2 is set as the default printer in the OS 21, the universal printing program 41 activates the supporting program 42 and displays an image prepared by the supporting program 42 in the information display field 52.

The basic print settings specification fields 53 allow the user to specify the basic settings such as the number of copies and page orientation. As illustrated in FIG. 3, for example, the print settings screen D2 includes a sheet size selection field 531 in the basic print settings specification field 53. In step A07, for example, a default sheet size specified in the universal printing program 41 or the supporting program 42 is displayed in the sheet size selection field 531. The “advanced settings” button 54 allows the user to activate advanced settings, including settings that are not included in the basic print settings specification fields 53. The “print” button 55 allows the user to activate printing under the specified print settings.

For example, in response to the advanced settings being activated through the “advanced settings” button 54 while the printer 2 is designated as the device for printing in the printer selection field 51 (A11), the universal printing program 41 transmits an instruction to the supporting program 42 for the printer 2 to start allowing the user to specify the advanced print settings (A12).

After the supporting program 42 is activated in response to receiving the instruction in step A12, the supporting program 42 obtains capabilities data of the printer 2. More specifically, the supporting program 42 requests the universal printing program 41 to obtain the capabilities data (A13). In response to receiving the request, the universal printing program 41 transmits a command to the printer 2 to request the capabilities data from the printer 2 (A14). The universal printing program 41 then passes the obtained capabilities data to the supporting program 42 (A15). The supporting program 42 thus obtains the capabilities data of the printer 2, including sheet sizes supported by the printer 2. Step A15 is an example of obtaining sheet size data representing a sheet size list including at least one first-type sheet size that is supported by the printer.

In step A14, the universal printing program 41 performs communication with the printer 2 via the OS 21 in accordance with, for example, the Internet Printing Protocol (“IPP”). In other embodiments, for example, the supporting program 42 may obtain the capabilities data directly from the printer 2 using, for example, the Management Information Base (“MIB”), instead of obtaining the capability data via the universal printing program 41.

The capabilities data obtained from the printer 2 includes parameters that can be specified as print settings. The capabilities data may further include, for example, remaining life of consumables, available trays, sheet sizes specified for or detected in trays, and available print resolutions. In other embodiments, for example, the printer 2 may have a function of performing image processing based on a received print job and performing printing using image data obtained from the image processing. The printing enabled by this function may be, for example, N-in-one printing, embedded printing such as printing with a watermark, or colorant saving printing. In a case where the printer 2 has an image processing function, the printer 2 may include the capability of the image processing in the capabilities data when providing the capabilities data to the supporting program 42 directly or indirectly. The printer 2 may provide the capabilities data including a status of the printer 2 to the supporting program 42 directly or indirectly.

The supporting program 42 can obtain sheet size data representing a list of sheet sizes supported by the printer 2, as the capabilities data of the printer 2. The sheet size data may be, for example, sheet sizes that a model of the printer 2 is capable of printing, sheet sizes that can be loaded into each feed trays of the printer 2, or the sheet sizes specified for or detected in the feed trays.

Based on the capabilities data of the printer 2, the supporting program 42 displays an advanced settings screen on the user IF 13 (A17). The advanced settings screen allows the user to specify advanced settings. The advanced settings screen displayed by the supporting program 42 includes parameters as options that the printer 2 supports. The supporting program 42 allows the user to specify one or more options through the displayed advanced settings screen. The advanced settings screen includes a relatively large number of settings for printing. Therefore, the advanced settings screen may include, for example, tabs that enable the user to switch between different setting items. The supporting program 42 may thus allow the user to select options by navigating through the tabs.

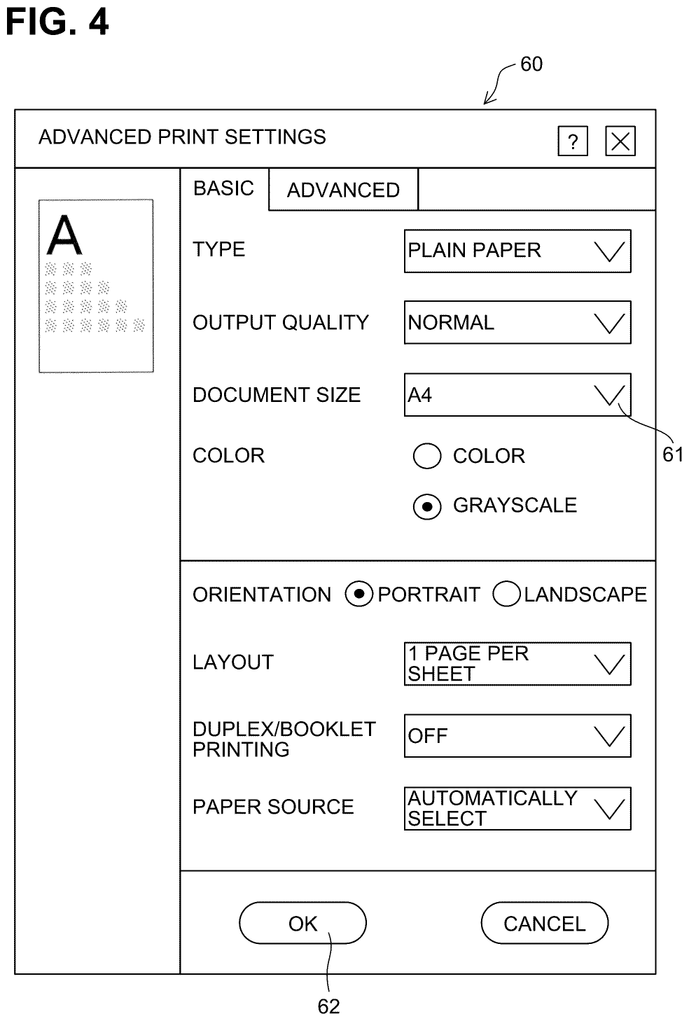

In step A17, the supporting program 42 may display, on the user IF 13, an advanced settings screen 60, as illustrated in FIG. 4. The advanced settings screen 60 is an example of a setting screen. The advanced settings screen 60 includes, for example, a document size specification field 61. The document size in the print settings refers to an image data size of the image to be printed. That is, the document size corresponds to the size of the image data to be transmitted from the editing application 43 to the universal printing program 41. The instruction including a display request for the advanced settings screen 60 is an example of a particular request. Step A17 in which the advanced settings screen 60 in response to the display request in step A12 is an example of displaying the setting screen.

The supporting program 42 displays the same size as the default sheet size specified in the printer 2, as the default document size, in the document size specification field 61 of the advanced settings screen 60 displayed in step A17. Examples of the default sheet size include the sheet size specified as default in the printer 2, and the sheet size specified for or detected in the default feed tray. The supporting program 42 can obtain the default sheet size specified in the printer 2 based on the capabilities data of the printer 2.

For example, even if the user creates a document in A3 size using the editing application 43, if the default sheet size specified in the printer 2 is A4, the default document size is set to A4. If a print execution instruction is issued in this state, the editing application 43 is likely to specify only a portion of the A3-size document, for example, an upper left A4-size area of a document image, as the image to be printed.

The user is allowed to provide a request to select a document size by operating the document size specification field 61 of the advanced settings screen 60. In response to receiving the document size selection request (A21), the supporting program 42 generates size list data representing available document size options, and displays a screen that allows the user to select a document size on the user IF 13 (A22). Step A22 is an example of generating document size data including document sizes to enable selection of one of the document sizes. The size list data is an example of document size data.

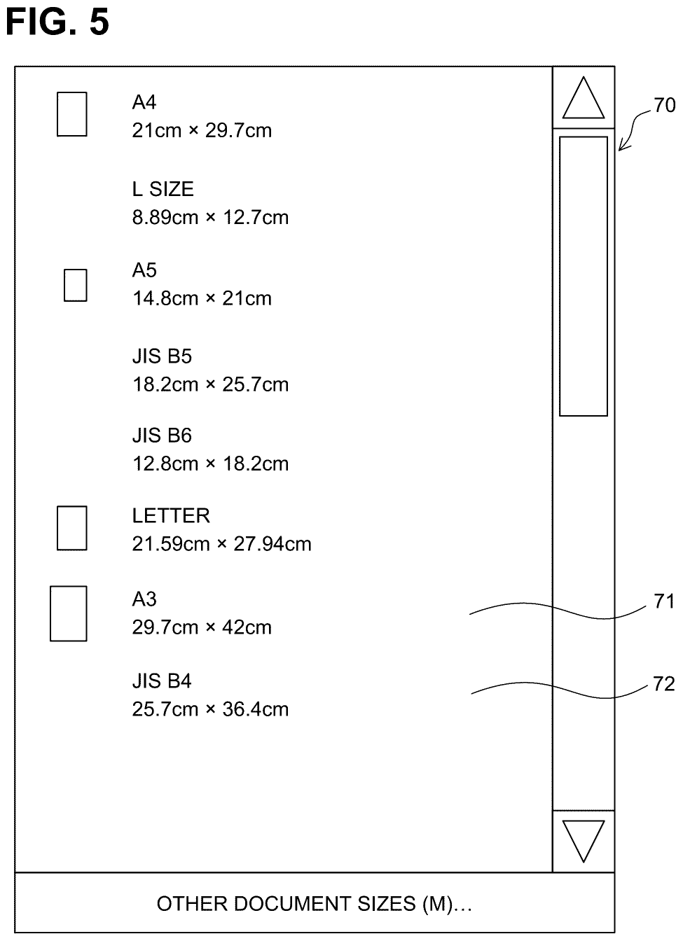

In response to receiving the document size selection request, the supporting program 42 displays, on the user IF 13, for example, a size list screen 70 that allows the user to specify the document size, as illustrated in FIG. 5. The size list screen 70 includes, as options, all the sheet sizes included in the sheet size data obtained from the printer 2 based on the capabilities data of the printer 2 obtained in step A15. The options listed on the size list screen 70 may further include a sheet size that is not included in the sheet size data obtained from the printer 2. For example, even if “A3” or “JIS B4” are not included in the sheet sizes supported by the printer 2, the supporting program 42 causes the size list screen 70 to additionally include options 71 and 72, as illustrated in FIG. 5. The option 71 may indicate “A3”, and the option 72 may indicate “JIS B4”.

More specifically, the supporting program 42 stores, in advance, sheet size data including sheet sizes supported by the supporting program 42. In step A22, the supporting program 42 generates size list data including one or more sheet sizes that are not included in the sheet size data obtained from the printer 2, but which are supported by the supporting program 42. Examples of the sheet sizes not included in the sheet size data obtained from the printer 2 include sheet sizes that are not supported by the printer 2 due to its functional limitations, sheet sizes that cannot be loaded in the feed trays of the printer 2, and sheet sizes that can be loaded in the feed trays of the printer 2 but are not currently loaded therein. The sheet size that is supported by the supporting program 42 and is not included in the sheet size data obtained from the printer 2 is an example of the second-type sheet size.

The supporting program 42 may have a particular condition for determining which sheet sizes are to be included in the size list data. In addition, the supporting program 42 may include, in the size list data, a sheet size that satisfies the particular condition, even if that sheet size is not included in the sheet size data obtained from the printer 2. If the supporting program 42 has such a condition, the supporting program 42 can generate size list data including appropriate sheet sizes without unnecessarily increasing the number of sheet sizes.

In one example, the supporting program 42 may determine a sheet size having an area twice as large as each sheet size included in the sheet size data obtained from the printer 2 as a sheet size to be included in the size list data. Further, the supporting program 42 may determine a sheet size having an area four times as large as each sheet size included in the sheet size data obtained from the printer 2 as a sheet size not to be included in the size list data. In another example, the supporting program 42 may include sheet size data representing the maximum sheet size that can be supported by the supporting program 42. The supporting program 42 may determine a sheet size in which at least one of the length or the width exceeds the maximum sheet size as a sheet size not to be included in the size list.

The user provides a document size specification instruction by specifying a specific size on the displayed size list screen 70 (A23). Step A23 is an example of a size selection process, and is an example of receiving selection of one of the at least one first-type sheet size via an interface of the information processing device. In response to receiving a request to display the advanced settings screen 60, the supporting program 42 can display options for document sizes that may include sheet sizes not supported by the printer 2, thereby increasing flexibility of document size selection.

The supporting program 42 determines whether the document size selected by the user is included in the sheet sizes supported by the printer 2 (A24). If the supporting program 42 determines that the selected document size is not supported by the printer 2 (opt: [Non-Supported Size]), the supporting program 42 displays a sheet selection dialog on the user IF 13 (A25). The sheet selection dialog may be a screen notifying the user that printing cannot be performed on a sheet of the same size as the document size specified in the document size specification field 61 and thus printing is to be performed after scaling, e.g., reducing or enlarging, the image. In addition, the sheet selection dialog allows the user to select the sheet size to be used for printing.

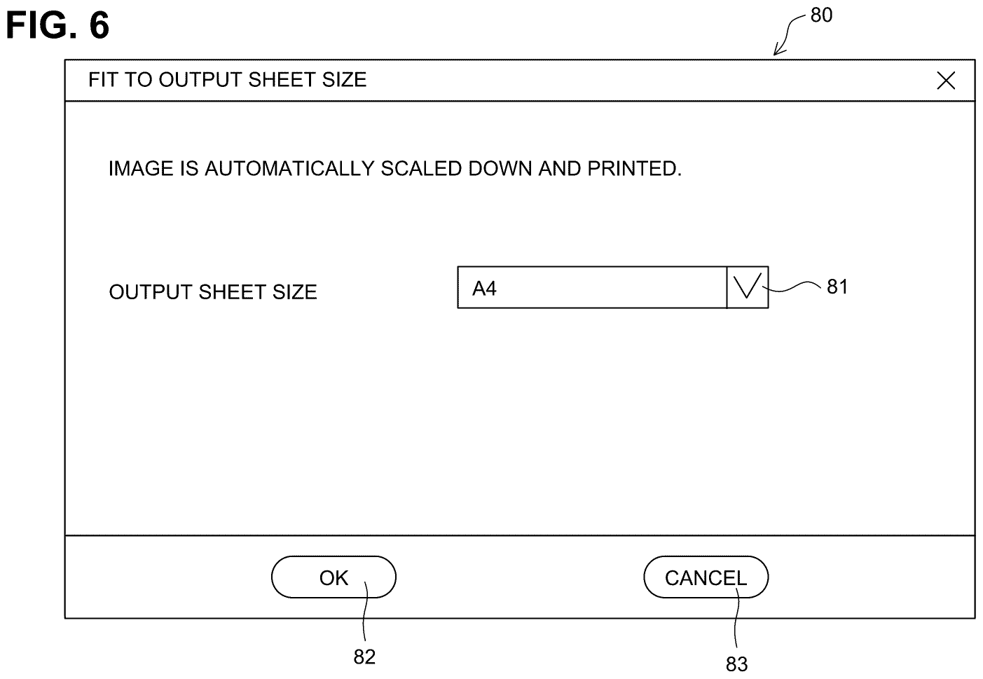

The supporting program 42 overlays the sheet selection dialog 80 on the advanced settings screen 60, allowing the user to specify an option through the sheet selection dialog 80, as illustrated in FIG. 6. The sheet selection dialog 80 in FIG. 6 includes a sheet size selection field 81, an OK button 82, and a cancel button 83. The supporting program 42, through the sheet size selection field 81, allows the user to select any sheet size from all the sheet sizes supported by the printer 2, but does not allow the user to select any sheet size not supported by the printer 2. The supporting program 42 allows the user to input to the OK button 82 or the cancel button 83 in the currently displayed sheet selection dialog 80 (A26). Step A26 may be an example of receiving selection of one of the at least one first-type sheet size via an interface of the information processing device.

The supporting program 42 does not allow the user to perform any operation on the advanced settings screen 60 while the sheet selection dialog 80 is displayed. In response to receiving an input to either the OK button 82 or the cancel button 83, the supporting program 42 dismisses the sheet selection dialog 80, and allows the user to perform an operation on the advanced settings screen 60.

If the input received in step A26 is an input to the cancel button 83 (opt: [Cancel]), the supporting program 42 cancels the document size specified in the document size specification field 61 of the advanced settings screen 60, and resets the document size to default (A27). Thereafter, the supporting program 42 displays the advanced settings screen 60 again. If the input received in step A26 is an input to the OK button 82, the supporting program 42 does not change the document size specified in the document size specification field 61 of the advanced settings screen 60, and allows the user to perform an operation on the advanced settings screen 60. In this case, the supporting program 42 specifies, as a parameter of the sheet size for the print settings, a sheet size that is different from the document size and is specified in the sheet size selection field 81 of the sheet selection dialog 80.

The timing for displaying the sheet selection dialog 80 in response to the selection of a document size that includes a sheet size not supported by the printer 2 is not limited to when the supporting program 42 receives an instruction to select, as the document size, a sheet size that is not supported by the printer 2, through an operation on the document size specification field 61. For example, the supporting program 42 may display the sheet selection dialog 80 when a sheet size not supported by the printer 2 is applied as the document size via an “apply” button, or when the supporting program 42 receives an instruction to complete the print settings while a sheet size not supported by the printer 2 is specified as the document size.

The user provides an instruction to complete the advanced print settings started in response to the instruction provided in step A11 by, for example, operating the OK button 62 of the advanced settings screen 60 (A31). In response to receiving a completion instruction to complete the print settings from the user, the supporting program 42 dismisses the advanced settings screen 60 and stores the specified print settings (A32). The supporting program 42 stores the print settings including, for example, the document size and the sheet size.

Then, the supporting program 42 passes the print settings to the universal printing program 41, and provides a completion notification that the specification of the advanced settings has been completed to the universal printing program 41 (A33). Based on the completion notification from the supporting program 42, the universal printing program 41 passes the print settings to the editing application 43 based on the notification from the supporting program 42, and provides a completion notification that the specification of the print settings has been completed to the editing application 43 (A34). In other embodiments, for example, the supporting program 42 may provide the print settings completion notification directly to the editing application 43. The editing application 43 thus activates the print settings screen (e.g., the print settings screen D2 of FIG. 3) displayed in step A07, thereby allowing the user to input instructions, such as an instruction to perform printing or an instruction to cancel printing.

As described above, the print settings screen D2 (refer to FIG. 3) includes the information display field 52 capable of displaying an image generated by the supporting program 42. In response to receiving user input in the information display field 52, the universal printing program 41 passes details of the input to the supporting program 42. For example, the supporting program 42 displays, in the information display field 52, a screen that allows the user to specify a document size. The supporting program 42 thus allows the user to provide a document size specification instruction through such a screen in the information display field 52. Even when the supporting program 42 receives the document size specified via the information display field 52, the supporting program 42 may preferably display the sheet selection dialog 80 if the specified document size is not supported by the printer 2.

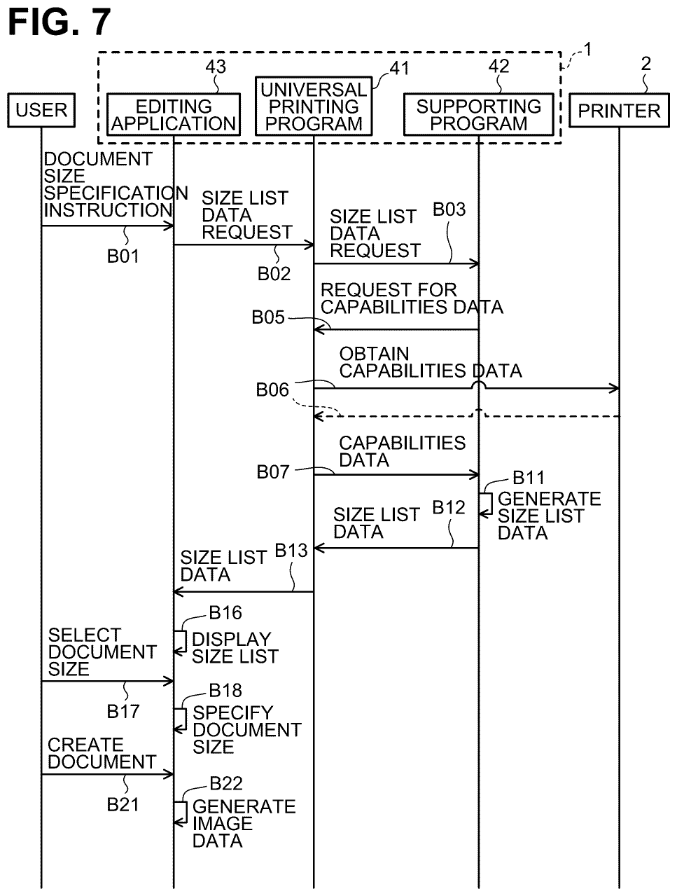

Next, a description will be provided on a procedure in which the user is allowed to also specify settings related to printing when creating or editing a document or an image using the editing application 43. For example, the editing application 43 provided by the vendor of the printer 2 may allow the user to edit an image with intension of printing the image by the printer 2. Hereinafter, referring to FIG. 7, a description will be provided on a procedure for generating an image to be printed.

In this procedure, when creating or editing a document, for example, the editing application 43 first allows the user to select the document size of the document to be printed by the printer 2. In response to receiving an instruction to specify a document size of the document to be printed by a user operation (B01), the editing application 43 requests the universal printing program 41 to transmit size list data (B02).

In response to receiving the request in step B02, the universal printing program 41 activates the supporting program 42 for the printer 2 that has been designated as a device for printing. Further, the universal printing program 41 requests the supporting program 42 to transmit data representing a list of document sizes supported by the printer 2 (B03). Step B03 is an example of a request based on a request for the sheet size list issued from the application program to the universal printing program 41, and is an example of a particular request.

After the supporting program 42 is activated in response to receiving the instruction in step B03, the supporting program 42 obtains capabilities data of the printer 2 (B05 to B07). Steps B05 to B07 are the same as steps A13 to A15 in the print settings specification procedure (refer to FIG. 2A). Step B07 is an example of obtaining sheet size data representing a sheet size list including at least one first-type sheet size that is supported by the printer.

The supporting program 42 generates size list data that provides document size options, based on the obtained capabilities data (B11). More specifically, in step B11, the supporting program 42 generates size list data. The size list data includes all the one or more sheet sizes included in the sheet size data obtained from the printer 2. In addition, the size list data further includes one or more sheet sizes that are not included in the sheet size data obtained from the printer 2, but are supported by the supporting program 42. The size list data may be used as document size data that enables the editing application 43 to receive selection of one of the document sizes. Step B11 is an example of generating document size data including document sizes to enable selection of one of the document sizes. The sheet size that is supported by the supporting program 42 and is not included in the sheet size data obtained from the printer 2 is an example of the second-type sheet size. The supporting program 42 may generate size list data including all the one or more sheet sizes supported by the supporting program 42, or may generate size list data including options determined based on a predetermined condition.

Subsequent to step B11, the supporting program 42 transmits the generated size list data to the universal printing program 41 (B12). Thereafter, the universal printing program 41 passes the size list data received from the supporting program 42 to the editing application 43 (B13). In response to the request for the sheet size list from the editing application 43, the supporting program 42 passes the size list data that may include one or more sheet sizes not supported by the printer 2, to the editing application 43 via the universal printing program 41, thereby increasing flexibility of document size selection on the editing application 43.

The editing application 43 displays, on the user IF 13, a screen indicating a size list based on the received size list data (B16), and allows the user to select a sheet size (B17). Based on the data received from the universal printing program 41, the editing application 43 displays a screen including the one or more sheet sizes not supported by the printer 2 as options of selectable document sizes, for example, as with the size list screen 70 of FIG. 5.

The editing application 43 specifies a size of a document to be created based on the user's selection received via the screen displayed in step B16 (B18). The editing application 43 receives an instruction to create a document from the user based on the document size selected by the user (B21). The editing application 43 generates image data representing an image of the document to be printed based on the user instruction (B22).

When the editing application 43 does not receive any size specification, the editing application 43 may, for example, specify a sheet size for printing to be the same size as the specified document size. That is, the editing application 43 may specify a sheet size that is not included in the sheet size data received from the printer 2. In this case, the image data generated in step B22 may have a sheet size that is not included in the sheet size data received from the printer 2. The editing application 43 may allow a sheet size to be specified separately from the document size.

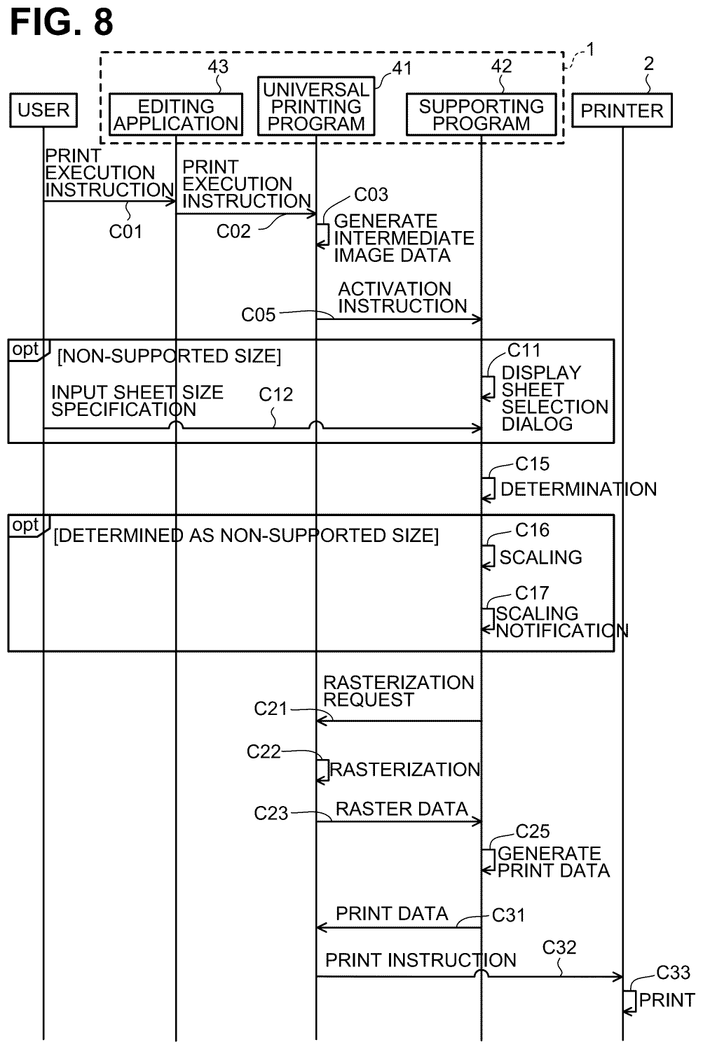

Next, a print execution procedure will be described with reference to FIG. 8. After specifying the image to be printed via the editing application 43, the user issues a print execution instruction via the editing application 43 (C01). More specifically, for example, based on the user's selection of the “Print” button 55 in the print settings screen D2 of FIG. 3, the editing application 43 determines that a print execution instruction for the universal printing program 41 has been received. The print execution instruction instructs the printer 2 to print the specified image.

The editing application 43 passes the details of the print execution instruction to the universal printing program 41 (C02). The universal printing program 41 thus obtains image data representing the image to be printed and the print settings, as the details of the print execution instruction, from the editing application 43.

The universal printing program 41 generates intermediate image data by converting the image data to an intermediate image data format based on the print settings received from the editing application 43 (C03). The image data included in the editing application 43 is of various types. The universal printing program 41 thus converts the received image data to intermediate image data suitable for generating print data. Nevertheless, in other embodiments, for example, when the received image data is in a suitable format, the generation of intermediate image data may be omitted, and the image data may be used as intermediate image data without any conversion.

In step C02, the editing application 43 passes the image data representing the image to be printed to the universal printing program 41 based on the document size specified in the received print settings. In step C03, the universal printing program 41 generates intermediate image data on the image data received from the editing application 43.

Prior to generating the intermediate image data, the universal printing program 41 may activate the supporting program 42 for the designated device, which may be the printer 2, and notify that processing for a print job has been started. In a case where the supporting program 42 is activated by the universal printing program 41, the supporting program 42 is allowed to pass various instructions to be used in the generation of intermediate image data, to the universal printing program 41 as necessary.

After generating the intermediate image data, the universal printing program 41 activates the supporting program 42 (C04). The supporting program 42 can obtain the intermediate image data generated by the universal printing program 41 and the print settings specified by the editing application 43 or the universal printing program 41, by requesting the intermediate image data from the universal printing program 41.

The supporting program 42 obtains sheet size specified in the print settings, and determines whether the selected sheet size is supported by the printer 2. In a case where the print settings specifying procedure of FIGS. 2A and 2B has been executed, the supporting program 42 retrieves the sheet size data from the print settings stored in step A32. In a case where the print settings specifying procedure has not been executed, the supporting program 42 retrieves the sheet size data from the print settings obtained in step C04.

If the supporting program 42 determines that the selected sheet size is not supported by the printer 2 (opt: [Non-Supported Size]), the supporting program 42 displays, on the user IF 13, a screen for allowing the user to select an output sheet size. The screen may be similar to the sheet selection dialog 80 of FIG. 6 (C11). For example, when the editing application 43 receives a print execution instruction without receiving an instruction to specify the advanced print settings (A11 in FIG. 2A), the editing application 43 may specify a sheet size that is the same size as the selected document size. In this case, the sheet size specified in the print settings might not be included in the sheet sizes supported by the printer 2.

If the supporting program 42 has not obtained the capabilities data of the printer 2, the supporting program 42 may request the capabilities data from the printer 2 prior to step C11. The steps for obtaining the capabilities data are the same as steps A13 to A15 in the print settings specification procedure (refer to FIG. 2A). The supporting program 42 thus obtains sheet sizes that are supported by the printer 2 based on the sheet size data included in the capabilities data of the printer 2.

The supporting program 42 receives a user's input via the displayed sheet selection dialog 80 (C12). The input specifies one of the sheet sizes supported by the printer 2 (C12). Step C12 is an example of a size selection process, and is an example of receiving selection of one of the at least one first-type sheet size via an interface of the information processing device, and is an example of receiving selection of one of the at least one first-type sheet size via an interface of the information processing device prior to the scaling. The supporting program 42 thus specifies a sheet size supported by the printer 2 as the output sheet size.

In other embodiments, for example, the supporting program 42 might not allow the user to input a cancellation instruction in step C12. That is, the supporting program 42 may display the sheet selection dialog 80 not including a cancellation button in step C11. Alternatively, in a case where the supporting program 42 allows the user to input a cancellation instruction and receives the cancel instruction, the supporting program 42 may notify the universal printing program 41 of the cancellation of the printing, and the steps subsequent to step C12 are thus not performed.

As described above, when an instruction to specify the advanced print settings is received (A11 in FIG. 2A) and a selection of a sheet size that is not supported by the printer 2 is received as the document size, the supporting program 42 has received a selection of one of the sheet sizes supported by the printer 2 via the sheet selection dialog 80 displayed in step A25. In this case, the sheet size specified in the print settings is supported by the printer 2, the supporting program 42 does not perform steps C11 and C12.

Subsequent to C12, the supporting program 42 determines, based on the print settings, whether the document size for the image to be printed is included in the sheet sizes supported by the printer 2 (C15). Step C15 is an example of determining whether a document size of an image to be printed based on the print instruction is included in the at least one first-type sheet size. The intermediate image data generated by the universal printing program 41 in step C03 is likely to be generated based on the document size. Therefore, the intermediate image data obtained by the supporting program 42 is likely to have a size based on the document size.

If the supporting program 42 determines that the document size for the image to be printed is not included in the sheet sizes supported by the printer 2 (opt: [Determined as Non-Supported Size]), the supporting program 42 executes scaling to enlarge or reduce the intermediate image data in accordance with the sheet size specified in the print settings or the sheet size selected in step C12 (C16). Step C16 is an example of scaling the image to be printed to fit one of the at least one first-type sheet size to generate a scaled image of the image to be printed. The supporting program 42 thus obtains the intermediate image data in a sheet size supported by the printer 2.

After scaling, the supporting program 42 causes the user IF13 to notify that the image to be printed is to be scaled and then printed (C17). Step C17 is an example of causing a user interface of the information processing device to notify that the image to be printed is to be scaled. Notifying the user in advance that the image is to be printed after being scaled may reduce confusion that may result from printing the scaled image.

The supporting program 42 passes the intermediate image data that has been scaled up or down, and requests the universal printing program 41 to rasterize the intermediate image data (C21). For example, in a case where editing needs to be performed based on the print settings that is received in the advanced print settings and is stored in step A32 of FIG. 2B, the supporting program 42 edits the intermediate image, the print settings or both, and requests rasterization.

Based on the request in step C21, the universal printing program 41 rasterizes the intermediate image data to generate raster data (C22). The raster data may be bitmap data. The universal printing program 41 then passes the generated raster data to the supporting program 42 (C23). Thus, the supporting program 42 obtains the raster data.

In other embodiments, for example, the supporting program 42 may perform rasterization instead of the universal printing program 41. More specifically, the supporting program 42 generates raster data by rasterizing the intermediate image data based on the intermediate image data that has been scaled up or down. The supporting program 42 may provide greater flexibility in rasterization than the universal printing program 41, which is likely to result in raster data that is suitable for printing by the printer 2. However, rasterization by the universal printing program 41 may enable the supporting program 42 to execute less processing, and may reduce the program size of the supporting program 42.

In other embodiments, the supporting program 42 may generate raster image data based on intermediate image data that is not scaled, and then scale the generated raster data, instead of scaling the intermediate image data in step C16. When the universal printing program 41 has a function of scaling image data, the supporting program 42 may instruct the universal printing program 41 to scale the image data. In this case, the supporting program 42 may cause the universal printing program 41 to scale the intermediate image data or the raster data.

Subsequent to step C23, the supporting program 42 encodes the raster image obtained in step C23 into PDL data to generate print data (C25). The supporting program 42 may process the raster data as necessary before generating the print data. Subsequent to step C25, the supporting program 42 passes the generated print data to the universal printing program 41 and instructs the universal printing program 41 to transmit the print data to the printer 2 (C31). Steps C21 to C31 is an example of causing the printer 2 to perform printing.

The print data to be passed from the supporting program 42 to the universal printing program 41 in step C31 may be any type as long as the print data is in a format that supported by the printer 2. The PDL data generated by the supporting program 42 may be in a format that can be printed by printers in addition to models of the printer 2.

In response to the instruction received from the supporting program 42, the universal printing program 41 transmits the print data to the printer 2 and instructs the printer 2 to perform printing (C32). In response to the print instruction, the printer 2 performs printing based on the received print data (C33). As a result, a printed matter based on the print instruction output from the editing application 43 is generated. After step C32, the universal printing program 41 provides a completion notification to the editing application 43.

In step C31, the supporting program 42 provides the print data to the printer 2 via the universal printing program 41. Nevertheless, in other embodiments, for example, the supporting program 42 may provide a print instruction and the print data directly to the printer 2. In still other embodiments, for example, in a case where the print settings include settings for image processing that can be executed by the printer 2, the supporting program 42 may generate a print instruction including the settings for image processing. In this case, after completing the transmission of the print data, the supporting program 42 may notify the universal printing program 41 of the completion of the print data transmission.

When the printer 2 has a function of scaling an image to be printed based on print data, the supporting program 42 may instruct the printer 2 to scale the image, instead of performing the scaling within the supporting program 42 or the universal printing program 41. Nevertheless, performing scaling with the supporting program 42 or the universal printing program 41 may reduce the processing load on the printer 2.

As described above, in the illustrative embodiment, in response to a request from the universal printing program 41, the supporting program 42 generates a list of document sizes including one or more sheet sizes not supported by the printer 2, and allows a user to select a document size from the list. This may thus enable printing of an image in a document size that is not supported by the printer 2. When an image in a document size that is not supported by the printer 2 is to be printed, the supporting program 42 causes the printer 2 to perform printing based on a scaled image that has been obtained by scaling the image to be printed to fit one of the sheet sizes supported by the printer 2. Therefore, such a configuration may thus enable the printer 2 to print on a sheet in a size that is supported by the printer 2, based on a scaled image obtained by scaling an image to be printed that has been passed from the editing application 43.

While the disclosure has been described in detail with reference to the specific embodiment thereof, this is merely an example, and various changes, arrangements and modifications may be applied therein without departing from the spirit and scope of the disclosure. Any apparatuses or devices having a printing function may be connected to the PC 1. Examples of such apparatuses or devices include multifunction peripherals, copying machines, and facsimile machines. A plurality of printers, for example, two or more printers may be connected to the PC 1.

The screens to be displayed on the user IF 13 illustrated in the illustrative embodiment are all examples. The words or indications on the screens and the screen layouts, such as the shapes of the objects and the backgrounds on the screen, illustrated in the illustrative embodiment are all examples. For example, FIG. 3 illustrates the print settings screen D2 including a single information display field 52. Nevertheless, the location, shape, size, and/or the number of information display fields 52 are not limited to the example of the illustrative embodiment. The print settings screen D2 might not necessarily include the information display field 52. The print execution procedure (refer to FIG. 8) might not necessarily include the notification step in step C17.

In the illustrative embodiment, when a document size is not included in the sheet sizes supported by the printer 2, an image to be printed is fitted to a sheet size selected by a user. Nevertheless, in other embodiments, selection of a sheet size by the user may be omitted. For example, the supporting program 42 may determine a sheet size based on the sheet size data of the printer 2.

In the illustrative embodiment, the supporting program 42 scales an image to be printed to fit a sheet size. Nevertheless, in other embodiments, the supporting program 42 might not necessarily scale up the image to fit the sheet size. For example, when a selected document size is smaller than an output sheet size that is supported by the printer 2 and the entirety of an image to be printed can be printed, the supporting program 42 may print the image without scaling or may allow the user to select whether to scale up the image.

The supporting program 42 may obtain the capabilities data of the printer 2 at a timing different from the example illustrated in FIG. 2A. In one example, in a case where the supporting program 42 is activated by the universal printing program 41 before the print settings screen D2 (refer to FIG. 3) is displayed, the supporting program 42 may obtain the capabilities data of the printer 2 by requesting the capabilities data from the printer 2 at that timing. In another example, the supporting program 42 may obtain the capabilities data of the printer 2 again after receiving the print execution instruction.

In other embodiments, for example, the universal printing program 41 may also activate the supporting program 42 in a case where the default printer is changed to the printer 2 through the OS 21 by a user's operation after the universal printing program 41 displays the print settings screen D2. In this case as well, for example, the supporting program 42 may display a particular screen that allows the user to provide an instruction for document size in the information display field 52.

In the illustrative embodiment, the description has been provided on only the printing operation in which the supporting program 42 is involved. However, the supporting program 42 may be involved in another operation in addition to the printing operation. Any program may be applicable instead of the supporting program 42, as long as the program receives an instruction from the OS 21 or the universal printing program 41 when printing is performed using the universal printing program 41. For example, the alternative program may be a print workflow application (PrintWorkflow) whose specification has been disclosed by Microsoft Corporation.

The manner for activating the supporting program 42 is not limited to the examples in the illustrative embodiment. In one example, the supporting program 42 may be activated in response to an activation instruction received directly from the OS 21. In another example, the supporting program 42 may be a resident program. In a case where the supporting program 42 is a resident program, the supporting program 42 may be configured to behave as described above in response to an activation instruction.

In any flowchart disclosed in the illustrative embodiment, steps may be executed in a different order or in parallel, as long as no contradiction occurs in the contents of the procedures.

The processing in all steps disclosed in the illustrative embodiment may be executed by hardware, such as a single CPU, multiple CPUs, an ASIC, or a combination thereof. The processing in all steps disclosed in the embodiment may be implemented in various aspects such as a recording medium storing a computer-readable program for executing the processing, or a method.

What is claimed is:

1. A non-transitory computer-readable storage medium for an information processing device, the information processing device including a controller, the non-transitory computer-readable storage medium storing computer-executable instructions for implementing a supporting program for a printer connectable to the information processing device, wherein the information processing device has an operating system including a universal printing program, the supporting program supports a plurality of particular sheet sizes,
wherein in response to the supporting program receiving a particular request from the universal printing program, the supporting program, that when executed by the controller, causes the information processing device to perform:
obtaining sheet size data representing a sheet size list including at least one first-type sheet size that is supported by the printer; and
generating document size data including document sizes to enable selection of one of the document sizes, the document sizes including the at least one first-type sheet size and at least one second-type sheet size, the at least one second-type sheet size being included in the plurality of particular sheet sizes supported by the supporting program and being not included in the sheet size data,
wherein the information processing device is incorporated with an application program, and
wherein, in response to the universal printing program receiving, from the application program, a print instruction that causes the printer to perform printing, the supporting program, that when executed by the controller, causes the information processing device to perform:
determining whether a document size of an image to be printed based on the print instruction is included in the at least one first-type sheet size;
based on the determination that the document size of the image to be printed is not included in the at least one first-type sheet size, scaling the image to be printed to fit one of the at least one first-type sheet size to generate a scaled image of the image to be printed; and
causing the printer to print the image to be printed, wherein in a case where the scaled image is generated, the scaled image is printed.

2. The non-transitory computer readable storage medium according to claim 1,
wherein the supporting program, when executed by the controller, causes the information processing device to perform:
based on the determination that the document size of the image to be printed is not included in the at least one first-type sheet size, receiving selection of one of the at least one first-type sheet size via an interface of the information processing device, and
wherein the scaling includes scaling the image to be printed to fit the selected one of the at least one first-type sheet size.

3. The non-transitory computer readable storage medium according to claim 1, wherein the scaling includes generating print data representing the scaled image obtained by the scaling in which the image to be printed is scaled to fit the one of the at least one first-type sheet size.

4. The non-transitory computer readable storage medium according to claim 1,
wherein the condition for regarding a sheet size as the second-type sheet size includes another condition.

5. The non-transitory computer readable storage medium according to claim 1,
wherein the supporting program, when executed by the controller, causes the information processing device to perform:
in a case where the information processing device performs the scaling, causing a user interface of the information processing device to notify that the image to be printed is to be scaled.

6. The non-transitory computer readable storage medium according to claim 1,
wherein the particular request is based on a request for the sheet size list issued from the application program to the universal printing program, and
wherein the generating the document size data includes passing the generated document size data to the application program to enable selection of one of the document sizes included in the document size data.

7. The non-transitory computer readable storage medium according to claim 6,
wherein the supporting program, when executed by the controller, causes the information processing device to perform:
in response to the universal printing program receiving the print instruction from the application program, based on the determination that the document size of the image to be printed is not included in the at least one first-type sheet size, receiving selection of one of the at least one first-type sheet size via an interface of the information processing device prior to the scaling, and
wherein the scaling includes scaling the image to be printed to fit the selected one of the at least one first-type sheet size.

8. The non-transitory computer readable storage medium according to claim 1,
wherein the particular request is a request to display a settings screen, and
wherein the supporting program, when executed by the controller, causes the information processing device to perform:
in response to the supporting program receiving an instruction including the particular request, displaying the settings screen on a user interface of the information processing device to enable selection of one of the document sizes included in the document size data.

9. The non-transitory computer readable storage medium according to claim 6,
wherein the supporting program, when executed by the controller, causes the information processing device to perform:
based on selection of one of the at least one second-type sheet size as the document size on the settings screen, receiving selection of one of the at least one first-type sheet size via the user interface of the information processing device, and
wherein the scaling includes scaling the image to be printed to fit the selected one of the at least one first-type sheet size.
